(19) United States
(12) Patent Application Publication
(10) Pub. No.: US 2026/0109301 A1
(43) Pub. Date: Apr. 23, 2026

(54) VEHICLE BICYCLE CARRIER ASSEMBLY

(71) Applicant: FORD GLOBAL TECHNOLOGIES, LLC, Dearborn, MI (US)

(72) Inventors: Stephen Jeffrey Moneypenny, San Diego, CA (US); Bradford Zercoe, San Jose, CA (US)

(21) Appl. No.: 18/924,220

(22) Filed: Oct. 23, 2024

(51) Int. Cl. B60R 9/10

(52) U.S. Cl. CPC B60R 9/10

(57) ABSTRACT

A device may include a first carrier arm including a first support member configured to hold a first tire of a bicycle against a vehicle cargo bed floor. A device may include a second carrier arm adjustably coupled to the first carrier arm, the second carrier arm including a second support member configured to hold a second tire of the bicycle against the vehicle cargo bed floor.

### TECHNICAL FIELD

This disclosure relates generally to bicycle carrier assemblies for vehicles and, more particularly, to bicycle carrier assemblies with telescoping arms.

### BACKGROUND

A vehicle can be used to transport a bicycle. Some vehicles rely on a carrier assembly to secure the bicycle within an area of the vehicle, such as a cargo area of the vehicle. A size of the cargo area can vary. That is, a large pickup truck can have a larger cargo bed than a small pickup truck.

### SUMMARY

In some aspects, the techniques described herein relate to a vehicle bicycle carrier assembly, including: a first carrier arm including a first support member configured to hold a first tire of a bicycle against a vehicle cargo bed floor; and a second carrier arm adjustably coupled to the first carrier arm, the second carrier arm including a second support member configured to hold a second tire of the bicycle against the vehicle cargo bed floor.

In some aspects, the techniques described herein relate to a vehicle bicycle carrier assembly, wherein the first carrier arm includes a lever and pawl that is operably connected to the lever, the pawl configured to engage a portion of the second carrier arm to couple the first carrier arm to the second carrier arm.

In some aspects, the techniques described herein relate to a vehicle bicycle carrier assembly, further including ratchet teeth of the second carrier arm, the pawl configured to engage one or more of the ratchet teeth to couple the first carrier arm to the second carrier arm.

In some aspects, the techniques described herein relate to a vehicle bicycle carrier assembly, wherein, when the pawl is engaged with one or more of the ratchet teeth, the second carrier arm is retractable relative to the first carrier arm and blocked from extending relative to the first carrier arm.

In some aspects, the techniques described herein relate to a vehicle bicycle carrier assembly, wherein the first carrier arm includes a first body portion configured to attach to a vehicle cargo bed side panel, a second body portion configured to couple the first carrier arm to the second carrier arm, and a bridging portion that connects the first body portion to the second body portion.

In some aspects, the techniques described herein relate to a vehicle bicycle carrier assembly, wherein the first carrier arm and the second carrier arm are configured to extend and retract along a first axis.

In some aspects, the techniques described herein relate to a vehicle bicycle carrier assembly, wherein the first support member and the second support member are configured to pivot about a second axis that is transverse to the first axis.

In some aspects, the techniques described herein relate to a vehicle bicycle carrier assembly, wherein at least one of the first support member and the second support member are pivotable to a stored position to allow a tailgate to pivot from an open position to a closed position.

In some aspects, the techniques described herein relate to a vehicle bicycle carrier assembly, wherein, when in the stored position, the first support member is transverse to the first carrier arm and the second support member is transverse to the second carrier arm.

In some aspects, the techniques described herein relate to a vehicle bicycle carrier assembly, wherein at least a portion of the vehicle cargo bed floor includes a surface of a tailgate, and one of the first support member and the second support member is configured to hold a respective one of the first tire and the second tire against the surface of the tailgate.

In some aspects, the techniques described herein relate to a vehicle bicycle carrier assembly, wherein the tailgate is in an open position.

In some aspects, the techniques described herein relate to a vehicle bicycle carrier assembly, including: a first carrier arm supportable on a vehicle cargo bed side panel and including a first support member configured to pivot relative to the first carrier arm and hold a first tire of a bicycle against a vehicle cargo bed floor; and a second carrier arm telescopically engaged with the first carrier arm and including a second support member configured to pivot relative to the second carrier arm and hold a second tire of the bicycle against the vehicle cargo bed floor.

In some aspects, the techniques described herein relate to a vehicle bicycle carrier assembly, wherein the first support member includes a first frame configured to hold the first tire of the bicycle and a first bracket configured to pivotably connect the first frame to the first carrier arm, and the second support member includes a second frame configured to hold the second tire of the bicycle and a second bracket configured to pivotably connect the second frame to the second carrier arm.

In some aspects, the techniques described herein relate to a vehicle bicycle carrier assembly, wherein the first bracket and the second bracket are adjustable between a plurality of fixed positions, wherein each position of the plurality of fixed positions corresponds to a different tire diameter.

In some aspects, the techniques described herein relate to a vehicle bicycle carrier assembly, wherein a locking pin is received within one of the plurality of fixed positions to hold the first and second brackets in a fixed position.

In some aspects, the techniques described herein relate to a vehicle bicycle carrier assembly, wherein the first carrier arm includes a lever and pawl that is operably connected to the lever, the pawl configured to engage a portion of the second carrier arm to couple the first carrier arm to the second carrier arm.

In some aspects, the techniques described herein relate to a vehicle bicycle carrier assembly, further including ratchet teeth of the second carrier arm, the pawl configured to engage one or more of the ratchet teeth to couple the first carrier arm to the second carrier arm.

In some aspects, the techniques described herein relate to a vehicle bicycle carrier assembly, wherein, when the pawl is engaged with one or more of the ratchet teeth, the second carrier arm is retractable relative to the first carrier arm and blocked from extending relative to the first carrier arm.

In some aspects, the techniques described herein relate to a vehicle bicycle carrier assembly, wherein at least a portion of the vehicle cargo bed floor includes a surface of a tailgate, and one of the first support member and the second support member is configured to hold a respective one of the first tire and the second tire against the surface of the tailgate.

In some aspects, the techniques described herein relate to a vehicle bicycle carrier assembly, wherein the tailgate is in an open position.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a selected portion of a vehicle showing a bicycle carrier assembly including a first carrier arm assembly and a second carrier arm assembly according to an exemplary embodiment of the present disclosure.

FIG. 2 is a close-up view of a support member of the bicycle carrier assembly of FIG. 1.

FIG. 3 is a sectional view of the fist carrier arm assembly of FIG. 1.

FIG. 4 is a perspective view of the bicycle carrier assembly of FIG. 1 with the second carrier arm assembly of the bicycle carrier assembly received within the first carrier arm assembly.

FIG. 5 is a side view of the bicycle carrier assembly of FIG. 4 showing a pawl in an engaged position.

FIG. 6 is another side view of the bicycle carrier assembly of FIG. 4 showing the pawl in a disengaged position.

FIG. 7 illustrates the bicycle carrier assembly of FIG. 1 with the first carrier arm assembly coupled to a vehicle cargo side panel and the second carrier arm assembly removed from the first carrier arm assembly.

FIG. 8 illustrates the first carrier arm assembly of FIG. 7 holding a rear tire of a bicycle.

FIG. 9 illustrates the second carrier arm assembly coupled to the first carrier arm assembly and holding a front tire of the bicycle of FIG. 8.

FIG. 10 illustrates a second support member of the second carrier arm assembly in a stored position.

### DETAILED DESCRIPTION

This disclosure relates generally to bicycle carrier assemblies for vehicles. An example bicycle carrier assembly includes a first carrier arm and a second carrier arm that is telescopically received in the first carrier arm. The first carrier arm assembly and the second carrier arm can support a bicycle in a vehicle cargo bed that is shorter than a bicycle with a vehicle tailgate in an open position. These and other features are discussed in greater detail in the following paragraphs of this detailed description.

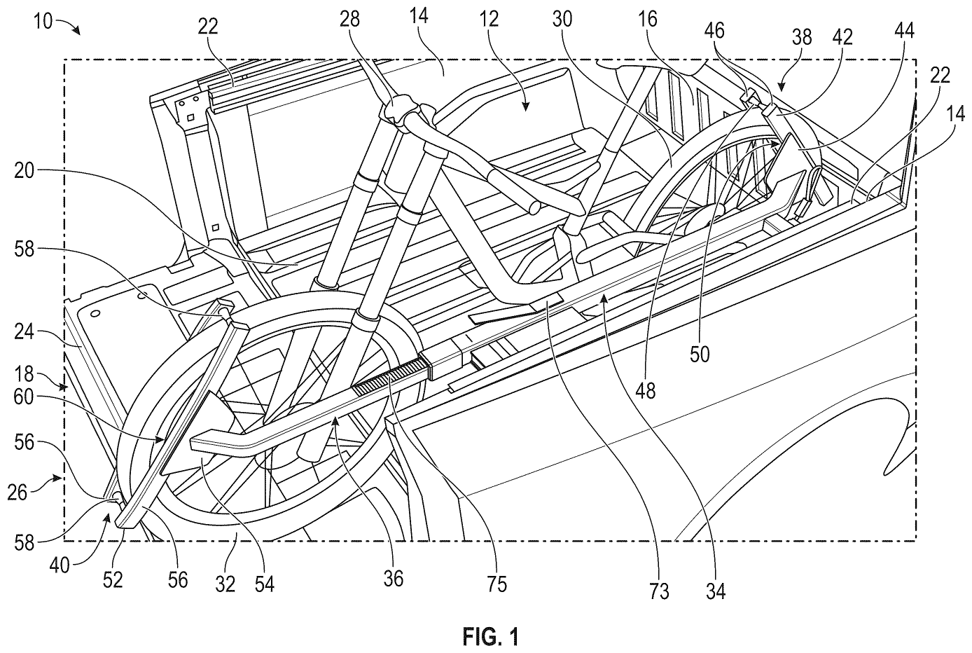

FIG. 1 illustrates a portion of a vehicle 10 having a cargo bed 12.

In the exemplary embodiment, the vehicle 10 is a pickup truck. The cargo bed 12 is located at the rear of the vehicle 10 and provides a space for carrying cargo. The open design of the cargo bed 12 allows for flexible loading and unloading, accommodating various shapes, sizes, and types of cargo. In this exemplary embodiment, the cargo bed 12 is used to carry recreational equipment such as a bicycle.

The cargo bed 12 is at least partially provided by bed side panels 14, a front wall 16, a tailgate 18, and a bed floor 20. The bed side panels 14 extend along a passenger side and a driver side of the cargo bed 12. The bed side panels 14 can each include a siderail 22. The front wall 16 spans between the bed side panels 14 at the front of the cargo bed 12. The front wall 16 serves as a barrier between the cargo bed 12 and the passenger compartment of the vehicle 10.

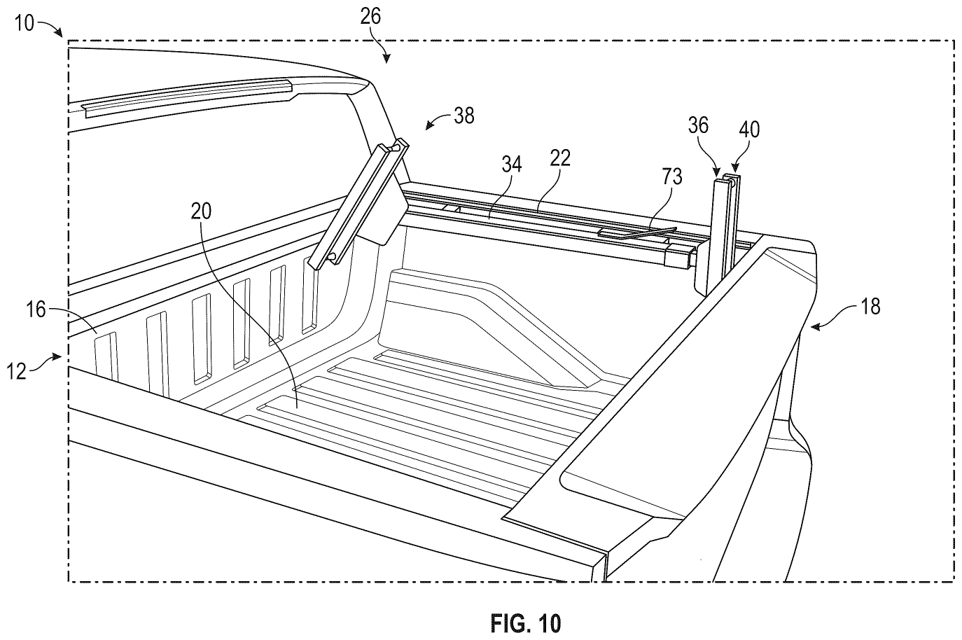

The tailgate 18 spans between the bed side panels 14 at the rear of the cargo bed 12. The tailgate 18 can pivot back and forth between an open position (FIG. 1) and a closed position (FIG. 10).

The bed floor 20 forms the bottom surface of the cargo bed 12. When the tailgate 18 is in the open position, a surface 24 of the tailgate 18 can effectively extend the bed floor 20 to allow longer items to be carried in the cargo bed 12.

In the exemplary embodiment, a bicycle carrier assembly 26 is arranged in the cargo bed 12. The bicycle carrier assembly 26 is configured to support a bicycle 28 in the cargo bed 12. In the exemplary embodiment, the bicycle carrier assembly 26 can support the bicycle 28 when the tailgate 18 is in an open position.

The bicycle carrier assembly 26 includes a first carrier arm 34 and a second carrier arm 36. The first carrier arm 34 includes a first support member 38 configured to hold a first tire 30 of the bicycle 28 against the bed floor 20. The second carrier arm 36 includes a second support member 40 configured to hold a second tire 32 against the bed floor 20.

The first support member 38 includes a first frame 42 and a first bracket 44. The first frame 42 includes opposed bars 46 and lateral bars 48. The opposed bars 46 are arranged on the sides of the first tire 30 and hold the bicycle 28 in an upright position. The lateral bars 48 connect the opposed bars 46 at the top and bottom of the first frame 42. An opening 50 between the lateral bars 48 allows the first tire 30 to be inserted into the first frame 42 between the opposed bars 46. The opening 50 is sized to allow the first tire 30 to fit through the first frame 42 while securely holding the first tire 30 against the bed floor 20.

In an embodiment example, the first bracket 44 is secured (e.g., bolted, welded, etc.) to the first frame 42. In another embodiment, the first bracket 44 is integral with the first frame 42. In a further embodiment, a size of the opening 50 may be adjusted to accommodate different tire widths by adjusting the distance between the opposed bars 46 (i.e., by increasing or decreasing a length of the lateral bars 48).

The second support member 40 similarly includes a second frame 52 and a second bracket 54. The second frame 52 includes opposed bars 56 and lateral bars 58. The opposed bars 56 are arranged on the sides on the second tire 32 and the bicycle 28 in an upright position. the lateral bars 58 connects the opposed bars at the top and bottom of the second frame 52. An opening 60 between the lateral bars 58 allows the second tire 32 to be inserted into the second frame 52 between the opposed bars 56. The opening 60 is sized to allow the second tire 32 to fit through the second frame 52 while securely holding the second tire 32 against the surface 24 of the tailgate 18.

In an embodiment, the second bracket 54 is secured (e.g., bolted, welded, etc.) to the second frame 52. In another embodiment, the second bracket 54 is integral with the second frame 52. In a further embodiment, a size of the opening 60 may be adjusted to accommodate different tire widths by adjusting the distance between the opposed bars 56 (i.e., by increasing or decreasing a length of the lateral bars 58).

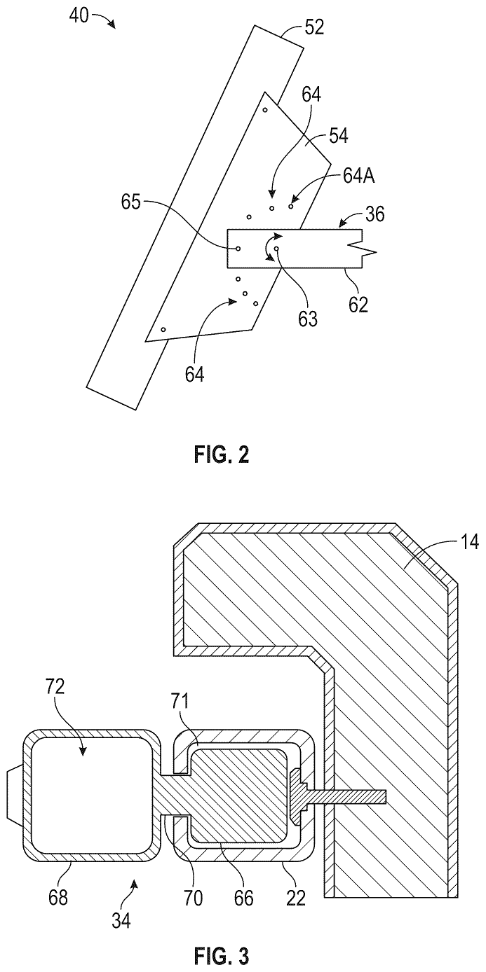

The first support member 38 and the second support member 40 are each adjustable between a plurality of fixed positions to accommodate different tire diameters. For example, as shown in FIG. 2, the second bracket 54 of the second support member 40 is pivotably connected to an end 62 of the second carrier arm 36 at a pivot 63, which allows the second support member 40 to pivot relative to the second carrier arm 36. The second bracket 54 includes a plurality of apertures 64. Each aperture 64 can include a marking that corresponds to a different tire diameter or size (e.g., 26 inches, 27 inches, 28 inches, etc.). The apertures 64 provide a visual reference for which position accommodates a particular tire. A locking pin 65 is inserted through the end 62 and the one of the apertures 64 to hold the second support member 40 in a fixed position. To adjust the second support member 40 for a specific tire diameter, a user can remove the locking pin 65 from the aperture 64 and pivot the second support member 40 relative to the second carrier arm 36. Once the user has aligned the second support member 40 to the desired aperture 64, the locking pin 65 can be inserted to hold the second support member 40 in a fixed position that corresponds to the diameter of the second tire 32.

In an embodiment, one of the apertures 64A is designated as a stored position. The aperture 64A is located at a point where the second support member 40 is transverse (e.g., perpendicular) to the second carrier arm 36. The second support member 40 can be pivoted to this position when the bicycle carrier assembly 26 is not holding a bicycle. Similar to adjusting for different tire diameters, the user can pivot the second support member 40 to the stored position (FIG. 10) and insert the locking pin 65 through the apertures 64A to hold the second frame 52 in the stored position. When in the stored position, the tailgate 18 can be pivoted from an open position to a closed position.

Referring to FIG. 1, the bicycle carrier assembly 26 holds the bicycle 28 near one of the bed side panels 14. Supporting the bicycle 28 near the bed side panels 14 provides other areas for cargo within the cargo bed 12.

As shown in FIG. 3, the first carrier arm 34 includes a first body portion 66, a second body portion 68, and a bridging portion 70 that connects the first body portion 66 and the second body portion 68. The first body portion 66 is configured to attach to the siderail 22 of the bed side panel 14. In an embodiment, the siderail 22 is secured (e.g., bolted, welded) to the bed side panel 14 and forms a C-shaped opening 71 that receives the first body portion 66. In an embodiment, the first body portion 66 is held in place within the C-shaped opening 71 via friction applied between an outer surface of the first body portion 66 and an inner surface of the C-shaped opening 71. In a further embodiment, the friction is generated by a spring mechanism that presses a friction element (e.g., pad) on one of the outer surface of the first body portion 66 and the inner surface of the C-shaped opening 71 against the other one of the outer surface of the first body portion 66 and the inner surface of the C-shaped opening 71. The second body portion 68 includes an opening 72 shaped to receive the second carrier arm 36.

Referring to FIGS. 1 and 4-6, the second carrier arm 36 is telescopically received within the opening 72 of the first carrier arm 34 to allow the first carrier arm 34 and the second carrier arm 36 to extend and retract relative to one another along a first axis A.

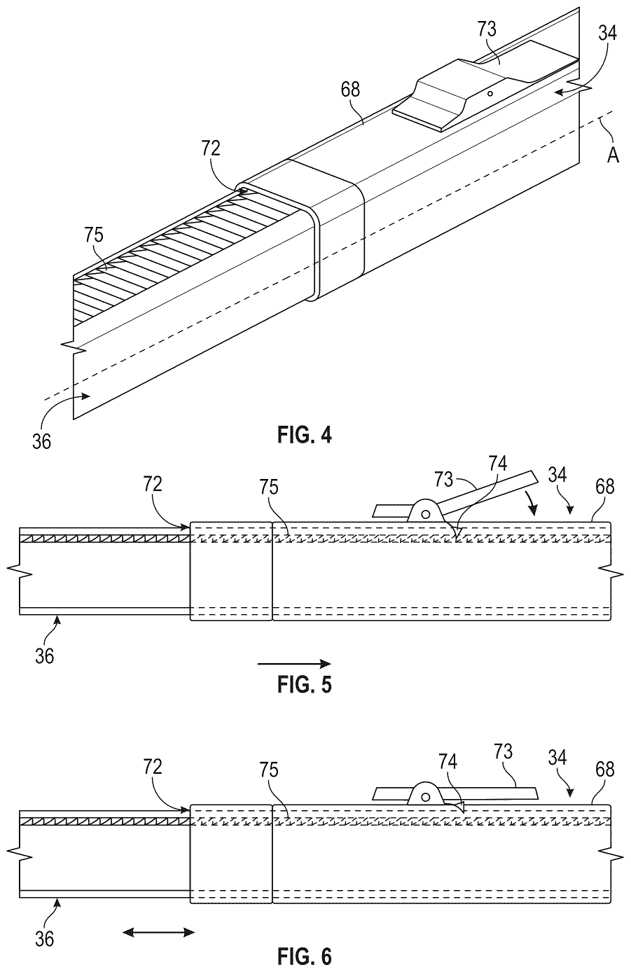

The first carrier arm 34 also includes a lever 73 and a pawl 74 that is operably connected to the lever 73. The lever 73 is arranged on an outer surface of the second body portion 68. The pawl 74 projects through the second body portion 68 of the first carrier arm 34. The lever 73 is configured to move the pawl 74 back and forth between an engaged position (FIGS. 1 and 5) and a disengaged position (FIGS. 4 and 6). When in the engaged position, the pawl 74 is configured to engage a portion of the second carrier arm 36 to couple the first carrier arm 34 to the second carrier arm 36. When in the disengaged position, the pawl 74 does not engage the second carrier arm 36.

The second carrier arm 36 is adjustably couplable to the first carrier arm 34. The second carrier arm 36 includes a plurality of ratchet teeth 75 for engaging the pawl 74. When in the engaged position (FIGS. 1 and 5), the lever 73 drives the pawl 74 into contact with one or more of the ratchet teeth 75 to lock the second carrier arm 36 in place. A user can operate the lever 73 to move the pawl 74 to the disengaged position (FIGS. 4 and 6). When in the disengaged position, the pawl 74 no longer contacts the ratchet teeth 75, which allows the second carrier arm 36 to slide in and out of the first carrier arm 34 along the first axis A.

In an embodiment, the second carrier arm 36 is telescopically engaged to the first carrier arm 34. The ratchet teeth 75 can be angled or sloped such that they create an asymmetrical profile. The angled side of each tooth faces a direction of allowed movement (i.e., retraction) and the vertical side faces a direction of restricted movement (i.e., extension). For example, when the pawl 74 is in the engaged position, the pawl 74 engages at least one tooth of the ratchet teeth 75. A user can push the second carrier arm 36 to drive the pawl 74 up the angled side and over the top of the tooth such that the pawl 74 engages the vertical side of an adjacent tooth of the ratchet teeth 75. This telescoping engagement allows incremental retraction of the second carrier arm 36 relative to the first carrier arm 34 and blocks extension of the second carrier arm 36 relative the first carrier arm 34.

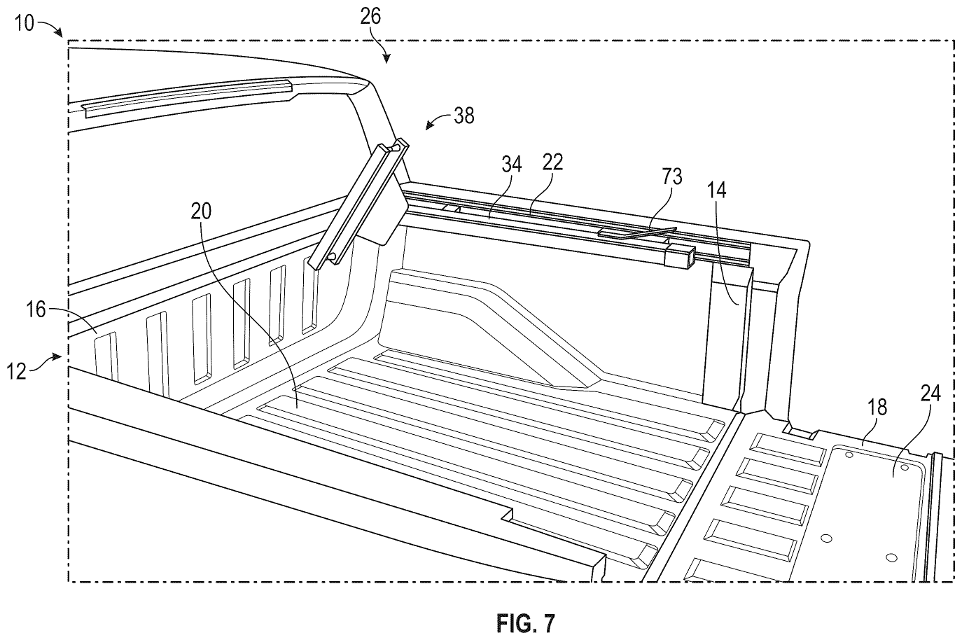

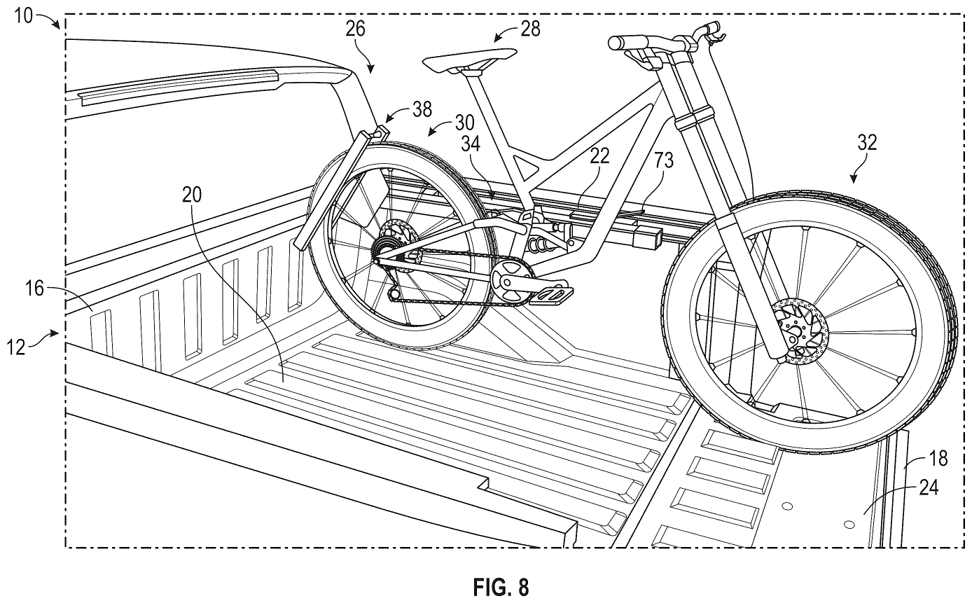

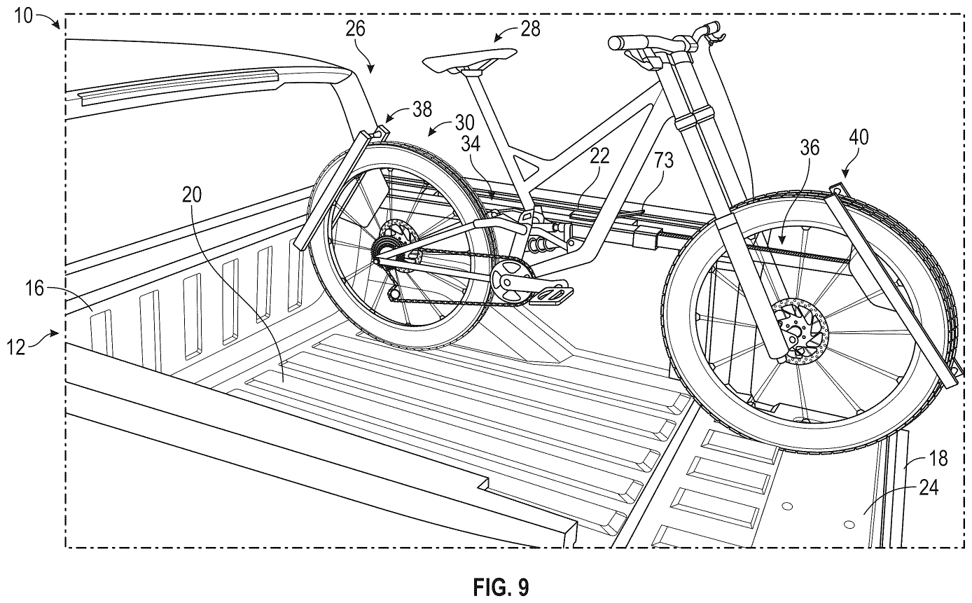

The bicycle carrier assembly 26 is operable to allow for quick and easy loading and unloading of the bicycle 28. FIGS. 7-10 illustrate a method of operating the bicycle carrier assembly 26. The first body portion 66 of the first carrier arm 34 is coupled to the siderail 22 on one of the bed side panels 14 (FIG. 7). The first tire 32 of the bicycle 28 is then received in the first support member 38 of the first carrier arm 34 (FIG. 8). The first support member 38 holds the first tire 30 against the bed floor 20. Next, the second carrier arm 36 is retracted within the second body portion 68 of the first carrier arm 34 (FIG. 9). The pawl 74 engages one or more teeth of the ratchet teeth 75 to couple the second carrier arm 36 to the first carrier arm 34. As the second carrier arm 36 is retracted within the first carrier arm 34, the second support member 40 contacts the second tire 32 of the bicycle 28 and holds the second tire 32 against the surface 24 of the tailgate 18. The first and second support members 38, 40 can be adjusted as described above to accommodate the tire diameters of the bicycle 28.

To remove the bicycle 28, a user operates the lever 73 to disengage the pawl 74 from the ratchet teeth 75. The second carrier arm 36 can be extended and/or removed from the first carrier arm 34 so that the bicycle 28 can be removed from the cargo bed 12 (FIGS. 8 and 9). Once the bicycle 28 is removed from the cargo bed 12, the second carrier arm 36 can be retracted within the first carrier arm 34 (FIG. 10). The second support member 40 can be adjusted to the stored position described above to allow the tailgate 18 to pivot to a closed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle bicycle carrier assembly, comprising:
a first carrier arm including a first support member configured to hold a first tire of a bicycle against a vehicle cargo bed floor; and
a second carrier arm adjustably coupled to the first carrier arm, the second carrier arm including a second support member configured to hold a second tire of the bicycle against the vehicle cargo bed floor.

2. The vehicle bicycle carrier assembly of claim 1, wherein the first carrier arm includes a lever and pawl that is operably connected to the lever, the pawl configured to engage a portion of the second carrier arm to couple the first carrier arm to the second carrier arm.

3. The vehicle bicycle carrier assembly of claim 2, further comprising ratchet teeth of the second carrier arm, the pawl configured to engage one or more of the ratchet teeth to couple the first carrier arm to the second carrier arm.

4. The vehicle bicycle carrier assembly of claim 3, wherein, when the pawl is engaged with one or more of the ratchet teeth, the second carrier arm is retractable relative to the first carrier arm and blocked from extending relative to the first carrier arm.

5. The vehicle bicycle carrier assembly of claim 1, wherein the first carrier arm includes a first body portion configured to attach to a vehicle cargo bed side panel, a second body portion configured to couple the first carrier arm to the second carrier arm, and a bridging portion that connects the first body portion to the second body portion.

6. The vehicle bicycle carrier assembly of claim 1, wherein the first carrier arm and the second carrier arm are configured to extend and retract along a first axis.

7. The vehicle bicycle carrier assembly of claim 6, wherein the first support member and the second support member are configured to pivot about a second axis that is transverse to the first axis.

8. The vehicle bicycle carrier assembly of claim 7, wherein at least one of the first support member and the second support member are pivotable to a stored position to allow a tailgate to pivot from an open position to a closed position.

9. The vehicle bicycle carrier assembly of claim 8, wherein, when in the stored position, the first support member is transverse to the first carrier arm and the second support member is transverse to the second carrier arm.

10. The vehicle bicycle carrier assembly of claim 1, wherein at least a portion of the vehicle cargo bed floor includes a surface of a tailgate, and one of the first support member and the second support member is configured to hold a respective one of the first tire and the second tire against the surface of the tailgate.

11. The vehicle bicycle carrier assembly of claim 10, wherein the tailgate is in an open position.

12. A vehicle bicycle carrier assembly, comprising:
a first carrier arm supportable on a vehicle cargo bed side panel and including a first support member configured to pivot relative to the first carrier arm and hold a first tire of a bicycle against a vehicle cargo bed floor; and
a second carrier arm telescopically engaged with the first carrier arm and including a second support member configured to pivot relative to the second carrier arm and hold a second tire of the bicycle against the vehicle cargo bed floor.

13. The vehicle bicycle carrier assembly of claim 12, wherein the first support member includes a first frame configured to hold the first tire of the bicycle and a first bracket configured to pivotably connect the first frame to the first carrier arm, and the second support member includes a second frame configured to hold the second tire of the bicycle and a second bracket configured to pivotably connect the second frame to the second carrier arm.

14. The vehicle bicycle carrier assembly of claim 13, wherein the first bracket and the second bracket are adjustable between a plurality of fixed positions, wherein each position of the plurality of fixed positions corresponds to a different tire diameter.

15. The vehicle bicycle carrier assembly of claim 14, wherein a locking pin is received within one of the plurality of fixed positions to hold the first and second brackets in a fixed position.

16. The vehicle bicycle carrier assembly of claim 12, wherein the first carrier arm includes a lever and pawl that is operably connected to the lever, the pawl configured to engage a portion of the second carrier arm to couple the first carrier arm to the second carrier arm.

17. The vehicle bicycle carrier assembly of claim 16, further comprising ratchet teeth of the second carrier arm, the pawl configured to engage one or more of the ratchet teeth to couple the first carrier arm to the second carrier arm.

18. The vehicle bicycle carrier assembly of claim 17, wherein, when the pawl is engaged with one or more of the ratchet teeth, the second carrier arm is retractable relative to the first carrier arm and blocked from extending relative to the first carrier arm.

19. The vehicle bicycle carrier assembly of claim 12, wherein at least a portion of the vehicle cargo bed floor includes a surface of a tailgate, and one of the first support member and the second support member is configured to hold a respective one of the first tire and the second tire against the surface of the tailgate.

20. The vehicle bicycle carrier assembly of claim 19, wherein the tailgate is in an open position.
